(19) United States
(12) Patent Application Publication
(10) Pub. No.: US 2007/0297126 A1
(43) Pub. Date: Dec. 27, 2007

(54) COMPUTER ENCLOSURE WITH BEZEL

(75) Inventors: CHIEH YANG, Tu-Cheng (TW); CHEN-LU FAN, Tu-Cheng (TW); LI-PING CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,117

(22) Filed: Jun. 23, 2006

(51) Int. Cl. G06F 1/16

(52) U.S. Cl. 361/683

(57) ABSTRACT

A computer enclosure includes a chassis (10), a front panel (20), and a bezel (30). The chassis has a positioning tab (123) with a pivot hole (125) defined therein. The front panel is fixed on the chassis, and defines an opening (22) adjacent the positioning tab of the chassis. The bezel has a bent portion (32). The bent portion is inserted through the opening of the front panel and pivotably engaged into the pivot hole of the positioning tab of the chassis.

### 1. FIELD OF THE INVENTION

The present invention relates to computer enclosures, and more particularly to a computer enclosure with a bezel.

### 2. DESCRIPTION OF RELATED ART

In a conventional computer system, a bezel is usually provided to decorate a computer enclosure. The bezel is often fixed on the computer enclosure with screws, which is very laborious and time-consuming in installation and removal of the bezel.

In some computer enclosures, the bezels are designed to be pivotably secured on the computer enclosures, thereby avoiding the need for removal when accessing the computer enclosures. For instance, a computer enclosure includes a front panel, a pivotable bezel, and a pair of female hinges. A pair of male hinges extends from one side of an inner surface of the bezel. Each male hinge includes a flange and a pivot column. Each female hinge includes a rear wall attachable to the front panel, and an engaging portion extending perpendicularly from the rear wall. The engaging portion defines a groove, and a notch spaced from the groove. The groove receives the flange of the corresponding male hinge. A recess is defined at the notch for pivotably receiving the pivot column of the corresponding male hinge. The bezel further forms a catch for engaging with a slot of the front panel. The bezel is thereby attached to the front panel. However, the structure of the computer enclosure is very complicated.

What is needed, therefore, is a computer enclosure with a bezel having a simple structure.

### SUMMARY OF THE INVENTION

A computer enclosure includes a chassis, a front panel, and a bezel. The chassis has a positioning tab with a pivot hole defined therein. The front panel is fixed on the chassis, and defines an opening adjacent the positioning tab of the chassis. The bezel has a bent portion. The bent portion is inserted through the opening of the front panel and pivotably engaged into the pivot hole of the positioning tab of the chassis.

Other advantages and novel features will be drawn from the following detailed description of preferred embodiments with attached drawings, in which:

### BRIEF DESCRIPTION OF THE DRAWINGS

FIG. 1 is an exploded, isometric view of a computer enclosure of a preferred embodiment of the present invention, the computer enclosure including a chassis, a front panel, and a bezel;

FIG. 2 is an isometric view of the bezel of FIG. 1;

FIG. 3 is an assembled view of FIG. 1, showing the bezel in a closed position; and

FIG. 4 is similar to FIG. 3, but showing the bezel in an open position.

### DETAILED DESCRIPTION OF THE INVENTION

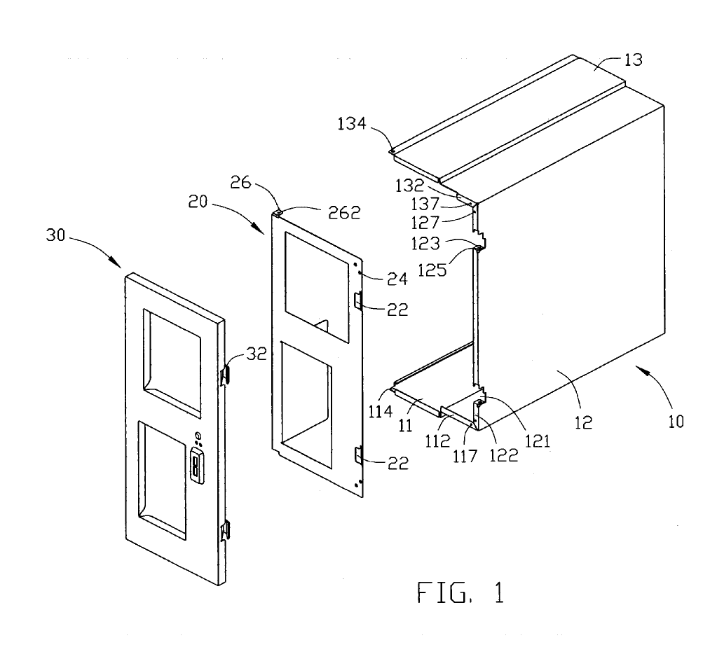

Referring to FIG. 1, a computer enclosure of a preferred embodiment of the present invention includes a chassis 10, a front panel 20, and a bezel 30.

The chassis 10 includes a bottom plate 11, a top plate 13, and a side plate 12. The bottom plate 11 is generally parallel to the top plate 13. The side plate 12 connects between the bottom plate 11 and the top plate 13 with an aperture formed therebetween. The side plate 12 is generally perpendicular to the bottom plate 11 and the top plate 13. The plates 11, 12, 13 respectively have flanges 112, 122, 132 formed at front edges thereof. The bottom plate 11 and the top plate 13 respectively define a mounting hole 114, 134 at a corner away from the side plate 12. The flanges 112, 132 of the bottom and top plates 11, 13 respectively define securing holes 117, 137 therein, adjacent the side plate 12. Two cutouts 121 are defined in the side plate 12 at the front edge extending to the flange 122. The cutouts 121 are respectively adjacent the bottom plate 11 and the top plate 13. A positioning tab 123 is bent in from a bottom edge of each cutout 121. A pivot hole 125 is defined in each positioning tab 123. The flange 122 of the side plate 12 defines two securing holes 127, respectively adjacent the securing holes 117, 137 of the bottom and top plates 11, 13.

The front panel 20 is generally rectangular, and defines two openings 22 adjacent a side edge, corresponding to the cutouts 121 of the side plate 12 of the chassis 10. Two securing holes 24 are respectively defined in two corners of the front panel 20, corresponding to the securing holes 117, 127, 137 of the chassis 10. Two bent tabs 26 (only one shown in FIG. 1) are respectively bent from ends away from the securing holes 24 of top and bottom edges of the front panel 20. Each tab 26 defines a mounting hole 262 therein, corresponding to the mounting holes 114, 134 of the chassis 10.

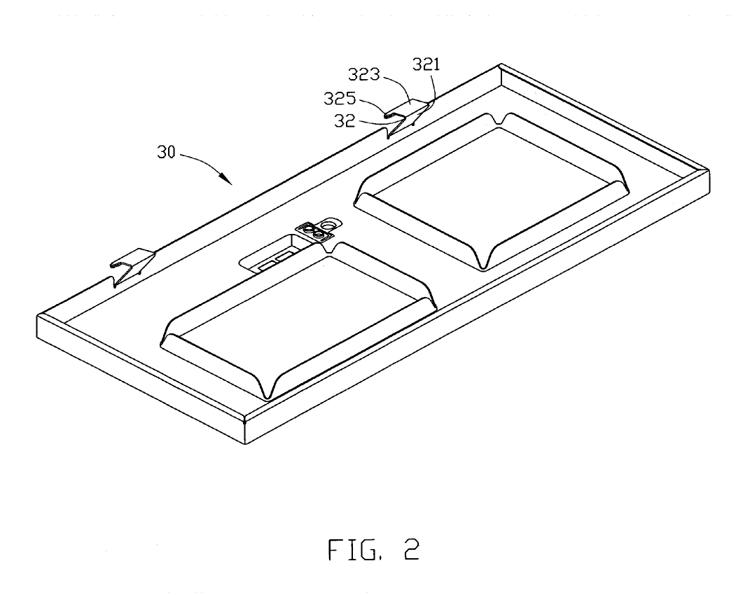

Referring to FIGS. 1 and 2, the bezel 30 has two generally V-shaped bent portions 32 formed on a side flange, corresponding to the openings 22 of the front panel 20. Each of the bent portions 32 includes a first bent piece 321 slanting in from the side flange, and a second piece 323 bent out from the first piece 321 generally parallel to the bezel 30. A pivot tab 325 extends down from the second piece 323 for inserting into the pivot hole 125 of the side plate 12 of the chassis 10.

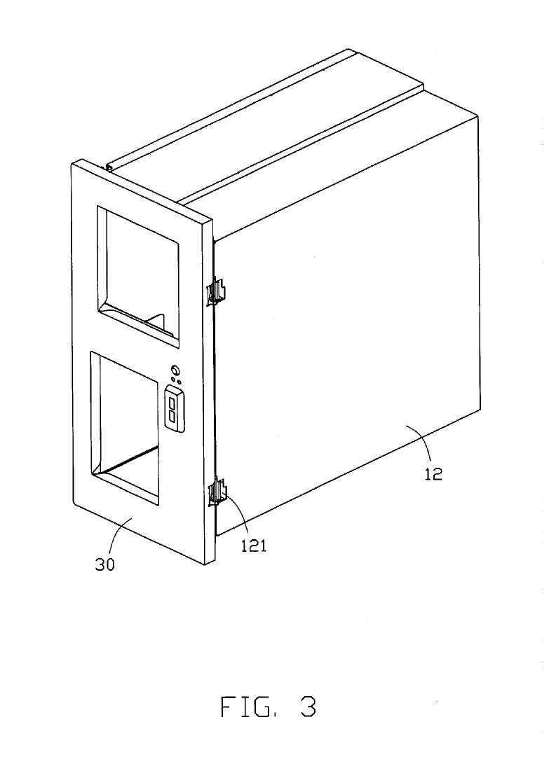

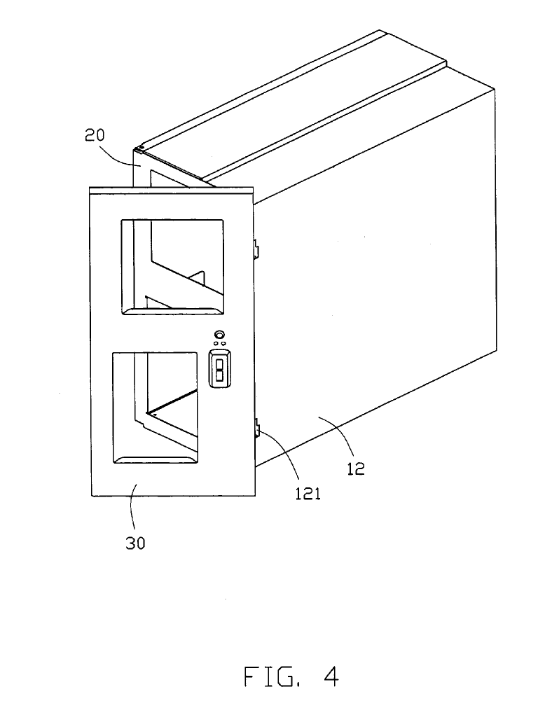

Referring also to FIGS. 3 and 4, before assembling the bezel 30, the front panel 20 is placed on the chassis 10 and abuts on the flanges 112, 122, 132, covering the aperture. The openings 22 of the front panel 20 are adjacent the cutouts 121 of the chassis 10. The securing holes 24 of the front panel 20 align with the securing holes 117, 127, 137 of the flanges 112, 122, 132, respectively. The mounting holes 262 of the bent tabs 26 of the front panel 20 align with the mounting holes 114, 134 of the chassis 10, respectively. A plurality of fasteners (not shown), such as screws, is screwed into the securing holes 24, 117, 127, 137, and the mounting holes 26, 114, 134. The front panel 20 is thus fixed on the chassis 10.

In assembly of the bezel 30, the bent portions 32 are inserted through the openings 22 of the front panel 20 to be received in the cutouts 121 of the chassis 10. The pivot tabs 325 are pivotably received into the pivot holes 125 of the positioning tabs 123 of the chassis 10. The bezel 30 is thus pivotably secured to the chassis 10.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A computer enclosure comprising:
a chassis having a positioning tab with a pivot hole defined therein;
a front panel fixed on the chassis, the front panel defining an opening adjacent the positioning tab of the chassis; and
a bezel having a bent portion, the bent portion inserting through the opening of the front panel and pivotably engaging in the pivot hole of the positioning tab of the chassis.

2. The computer enclosure as described in claim 1, wherein the bent portion comprises a first bent piece slanting in from an edge of the bezel, and a second piece bent out from the first piece.

3. The computer enclosure as described in claim 2, wherein the bent portion is generally V-shaped.

4. The computer enclosure as described in claim 2, wherein a pivot tab extends from the second bent piece of the bent portion of the bezel, for pivotably inserting into the pivot hole of the positioning tab of the chassis.

5. The computer enclosure as described in claim 1, wherein the chassis comprises a side plate with a cutout defined therein, and the positioning tab is bent in from an edge of the cutout.

6. The computer enclosure as described in claim 5, wherein the chassis further comprises a bottom plate and a top plate each perpendicular to the side plate, the bottom plate, the top plate, and the side plate having flanges formed at adjacent edges thereof.

7. The computer enclosure as described in claim 6, wherein the flanges of the chassis define a plurality of securing holes therein, and the bezel defines a plurality of securing holes corresponding to the securing holes of the flanges of the chassis, a plurality of fasteners extending into the securing holes of the flanges of the chassis and the bezel thereby securing the front panel to the chassis.

8. A computer enclosure comprising:
a chassis defining two pivot holes therein; and
a bezel having two bent portions, each of the bent portions comprising a first bent piece slanting in from an edge thereof and a second piece bent out from the first piece, two pivot tabs respectively extending from the second pieces for pivotably engaging in the pivot holes of the chassis, thereby the bezel being pivotably secured on the chassis.

9. The computer enclosure as described in claim 8, further comprising a front panel secured on the chassis, the front panel defining two openings for the pivot tabs being inserted therethrough to engage into the pivot holes of the chassis.

10. The computer enclosure as described in claim 8, wherein the chassis comprises a side plate with two cutouts defined therein, a positioning tab is bent in from an edge of each cutout, and the pivot holes are defined in the positioning tabs.

11. The computer enclosure as described in claim 9, wherein the chassis further comprises a bottom plate and a top plate each perpendicular to the side plate, the bottom plate, the top plate, and the side plate having flanges formed at adjacent edges thereof.

12. The computer enclosure as described in claim 11, wherein the flanges of the chassis define a plurality of securing holes therein, and the bezel defines a plurality of securing holes corresponding to the securing holes of the flanges of the chassis, a plurality of fasteners extending into the securing holes of the flanges of the chassis and the bezel thereby securing the front panel to the chassis.

13. The computer enclosure as described in claim 8, wherein the bent portions of the bezel are generally V-shaped.

14. The computer enclosure as described in claim 8, wherein the second piece is generally parallel to the bezel.

15. A computer enclosure comprising:
a chassis having a plurality of plates connecting together with an aperture formed therebetween;
a front panel fixed to the chassis and covering the aperture, the front panel defining an opening;
a bezel covering the front panel; and
an interlocking structure formed between the chassis and the bezel, the interlocking structure extending through the opening and pivotably connecting the chassis with the bezel.

16. The computer enclosure as described in claim 15, wherein the interlocking structure comprises a bent portion with a pivot tab extending from the bezel, and a positioning tab with a pivot hole extending from the chassis, the bent portion inserting through the opening of the front panel to allow the pivot tab to insert into the pivot hole.

17. The computer enclosure as described in claim 16, wherein the bent portion has a V shape, and the pivot tab extends downward from the bent portion.

18. The computer enclosure as described in claim 16, wherein one of the plates of the chassis defines a cutout for receiving the bent portion, the positioning tab being formed from said one of the plates at the cutout.
